(19) United States
(12) Patent Application Publication
(10) Pub. No.: US 2007/0200278 A1
(43) Pub. Date: Aug. 30, 2007

(54) Apparatus for mounting accessories to pottery wheels

(76) Inventor: Sam Lester, Lynchburg, VA (US)

Correspondence Address: CARACAPPA AND ASSOCIATES, PC, 9712 FOREST ROAD, GOODE, VA, 24556, US

(21) Appl. No.: 11/364,817

(22) Filed: Feb. 28, 2006

(51) Int. Cl. B28B 1/00; B28B 17/00

(52) U.S. Cl. 264/310; 425/459; 425/263; 264/633; 264/679; 264/311; 249/114.1; 249/134

(57) ABSTRACT

A porous bat may be used on a pottery wheel including a locating pin at a nominal location. The porous bat includes an elongated hole at a location corresponding to the nominal location. The elongated hole is adapted to slidably fit over the locating pin. The hole has a first axis with a dimension sized to fit over the locating pin and a second axis with a dimension larger than the first dimension to compensate for variations in the location of the locating pin on the pottery wheel.

### FIELD OF THE INVENTION

The present invention relates to pottery wheel accessories, and more specifically to apparatus for mounting such accessories to pottery wheels.

### BACKGROUND OF THE INVENTION

Potters often use pottery wheels to make pottery. To facilitate productivity, attachments, including trimming apparatuses, fixtures to hold the pottery during fabrication, trimming, shaping and decorating, and in particular bats, are often used. Currently, there are a variety of mechanical methods used to mount these attachments on a pottery wheel, also called a wheel head. One of the most common is to use bolt-heads as locating pins mounted in holes drilled at nominally standard locations in the pottery wheel. More specifically, the pottery wheel has holes drilled at points nominally along a diameter at a radius of, for example, 5 inches. Bolts having a specified head size, e.g. ¼-20 hex-head bolts, are mounted in the holes. Wheel manufacturers do not, however, precisely locate the holes in the same location. Also, there are multiple wheel manufacturers with varying tolerances and multiple methods for mounting the wheel head to the axle around which it rotates. Because the holes in the wheel head may not be located precisely, accessories may not fit on a particular pottery wheel without some means to adjust the location of the accessory to compensate for the variations in the location of the holes. Attachment manufacturers form holes in the accessories at the approximate location of the holes in the wheel head. The holes are then aligned with the heads of the bolts mounted on the pottery wheel. One hole is elongated to accommodate the variation in the hole location.

Often the work takes longer than one session and/or when completed needs to remain undisturbed until it dries. In such a situation, it is advantageous to be able to remove the completed or partially completed work from the wheel so that wheel may be used for other work. Accessories called bats may be used for this purpose. Bats are flat round trays, usually the size of the pottery wheel, which may be removed from, and remounted on, the pottery wheel. The bat has holes at locations corresponding to those of the locating pins on the pottery wheel. Before beginning work which will require several sessions, the potter mounts the bat on the pottery wheel. The locating pins hold the bat on the pottery wheel. The work is then performed on top of the bat. When the session is over, the bat, with the completed or partially completed work-piece on it, is lifted off the wheel. The wheel, thus, becomes available for different work.

Bats made from non-porous material, e.g. plastic or masonite, are currently available which may be dismounted and remounted on a pottery wheel. The non-porous bat has holes in it, at locations corresponding to the nominal locations of the bolts: i.e. along a diameter and at a radius of 5 inches. The size of these holes is slightly larger than the size of the bolt heads. In an existing plastic non-porous bat, one hole is substantially round while the other is oval-shaped to compensate for variations in the locations of the locating pins on the pottery wheel. The bat, thus, may be mounted on and removed from the pottery wheel as work on the work-piece progresses.

Porous bats, such as those made from plaster, are also available and provide advantages that non-porous bats do not. For example, a work-piece on a non-porous bat will begin to dry from the outside surfaces, except the surface on the non-porous bat. This leads to uneven drying. A porous bat, on the other hand, absorbs water so all surfaces of the work-piece, including that against the bat, will dry allowing the work-piece to dry more evenly. Also, because the porous bat absorbs the moisture, the potter will be able to release the work-piece from the bat without having to cut it off with a wire. Plaster bats are also easy and economical to fabricate, and a potter may make as many plaster bats as needed by constructing a dam around the edge of the pottery wheel, e.g. by using wide tape or clay. The resulting volume is filled with plaster. When the plaster sets, the dam is removed and the bat may be used. The bat may be attached to the pottery wheel using clay as an adhesive between the top of the pottery wheel and the bottom of the bat. This requires that the bat be recentered manually whenever it is remounted on the pottery wheel.

Some attempts have been made to allow a plaster bat to use the same attachment mechanism as described above with respect to the non-porous bats. For example, as described above, bolts may be mounted in holes drilled in the pottery wheel, then the plaster for the bat poured on the pottery wheel, as described above. When the plaster has set, it will fit atop the bolts and not require clay as an adhesive or manual recentering. However, because the holes in different pottery wheels are not located in precisely the same location, such a bat may not fit onto the bolts on a different pottery wheel. Porous bats, e.g. plaster bats, are also made commercially, sometimes using rubber grommets within holes formed at locations corresponding to the nominal locations of the bolts on a pottery wheel. However, for the same reason, the commercially produced bat may not fit onto the bolts in a particular pottery wheel. In addition, plaster is soft and brittle. Repeatedly removing and remounting a plaster bat made as described above on a pottery wheel, even the pottery wheel on which is was originally fabricated, eventually leads to the bolt heads scraping the holes in the bat, making them larger and allowing the bat to slip on the pottery wheel.

Prior solutions to this problem involved attaching locating pins on the pottery wheel the locations of which may be adjusted. The locations of the locating pins are adjusted to correspond to the location of the holes in the accessory. This permits bats made on different pottery wheels to be mountable on other pottery wheels, and also permits accurate centering of the bat on the pottery wheel. However, such locating pins are more expensive than the ¼-20 hex head bolts. In addition, beginning pottery students do not require such accuracy in recentering work pieces.

The ability to fabricate plaster bats which may be mounted on different pottery wheels using the relatively standard, less expensive, bolt-head locating pins is desirable.

### BRIEF SUMMARY OF THE INVENTION

In accordance with principles of the present invention, a porous bat may be used on a pottery wheel including a locating pin at a nominal location. The porous bat includes an elongated hole at a location corresponding to the nominal location. The elongated hole is adapted to slidably fit over the locating pin. The hole has a first axis with a dimension sized to fit over the locating pin and a second axis with a dimension larger than the first dimension to compensate for variations in the location of the locating pin on the pottery wheel.

### BRIEF DESCRIPTION OF THE DRAWING

In the drawing:

FIG. 1 is a diagram illustrating a pottery wheel, including locating pins, on which the present invention may be practiced;

FIG. 2 is a diagram of a round collar adapted to operate with the locating pin illustrated in FIG. 1 according to principles of the present invention;

FIG. 3 is a diagram of an elongated collar adapted to operate with the locating pin illustrated in FIG. 1 according to principles of the present invention;

FIG. 4 is a diagram illustrating how the round and elongated collars and may be mounted on the locating pin of FIG. 1;

FIG. 5, FIG. 6, and FIG. 7 illustrate alternate embodiments of elongated collars according to the present invention, such as is illustrated in FIG. 3;

FIG. 8 is a diagram illustrating a method for fabricating a plaster bat using collars illustrated in FIG. 2, FIG. 3, FIG. 5, FIG. 6, and/or FIG. 7;

FIG. 9 is a diagram illustrating a mold which may be used to fabricate bats according to principles of the present invention;

FIG. 10 is a diagram illustrating a method for fabricating a plaster bat using collars illustrated in FIG. 2, FIG. 3, FIG. 5, FIG. 6, and/or FIG. 7 in conjunction with the mold illustrated in FIG. 9; and

FIG. 11 is a diagram of a plaster bat fabricated according to the present invention.

### DETAILED DESCRIPTION OF THE INVENTION

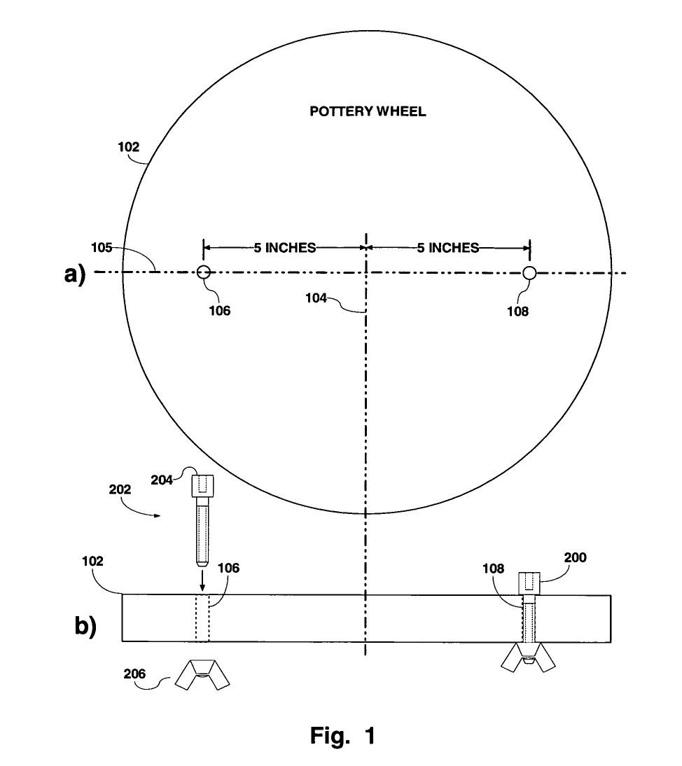

FIG. 1 is a diagram of a pottery wheel 102 in which holes have been drilled for locating pins at nominal locations. FIG. 1a illustrates a top view of a pottery wheel 102 and FIG. 1b illustrates a side view of the pottery wheel 102. Two holes, 106 and 108 are drilled through the pottery wheel 102 nominally along a diameter 105 and at respective radii of 5 inches. As described above, the holes 106 and 108 are generally drilled by the pottery wheel manufacturer but sometimes are drilled by the owner of the pottery wheel. Thus, while the holes are nominally at 5 inch radii along a diameter, there may be a relatively wide tolerance around that nominal location. Respective bolts 202, having a head 204, are inserted into the holes 106,108, and secured there with a nut, such as a wing nut 206. This is illustrated in FIG. 1b. The bolt head 204 acts as a locating pin 200 on the surface of the pottery wheel 102.

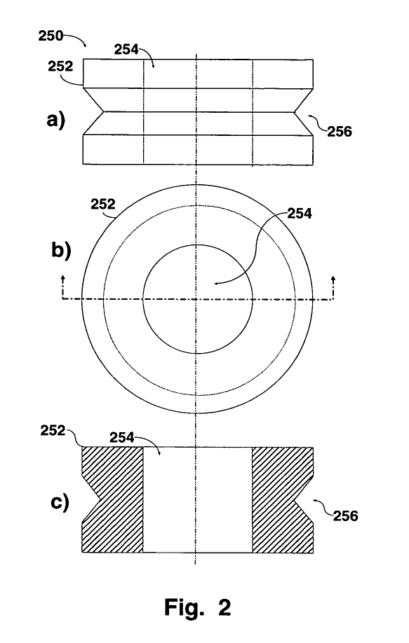

FIG. 2 is a diagram of a round collar 250 adapted to operate with the locating pin 200 illustrated in FIG. 1. FIG. 2a is a side view of a collar 250, FIG. 2b is a top view of the collar 250 and FIG. 2c is a cut-away side view of the collar 250. The collar 250 is preferably fabricated from an abrasion resistant material such as aluminum or hard plastic. The collar includes a solid body 252 which is generally annular forming a hole 254. The hole 254 is substantially round and sized to fit over the locating pin 200 illustrated in FIG. 1. That is, the hole 254 is slightly larger than the diameter of the head 204 of the bolt 202.

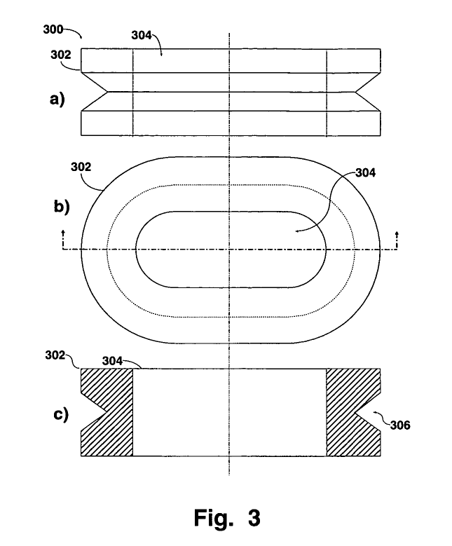

FIG. 3 is a diagram of an elongated collar 300 adapted to operate with the locating pin 200 illustrated in FIG. 1 according to principles of the present invention. FIG. 3a is a side view of a collar 300, FIG. 3b is a top view of the collar 300 and FIG. 3c is a cut-away side view of the collar 300. The collar 300 is also preferably an abrasion resistant material such as aluminum or hard plastic. The collar includes a solid body 302 which is generally annular forming an elongated hole 304 having a major (longer) and a minor (shorter) axis. The hole 304 is sized to fit over the locating pin 200 illustrated in FIG. 1. More specifically, in the illustrated embodiment, the minor axis has a first dimension which is slightly larger than the diameter the locating pin 200, i.e. of the head 204 of the bolt 202. The major axis has a second dimension which is substantially larger than the diameter of the locating pin 200, i.e. of the head 204 of the bolt 202. In the illustrated embodiment, the major axis is roughly 2½ times larger than the minor axis. The ratio of major-to-minor axis is not critical provided the dimension of the major axis is large enough to compensate for variations in the location of the locating pins 200 from one pottery wheel to another, as described in more detail below. For example, in a preferred embodiment, the major axis is substantially ½ inch and the minor axis is substantially ⅜ inch.

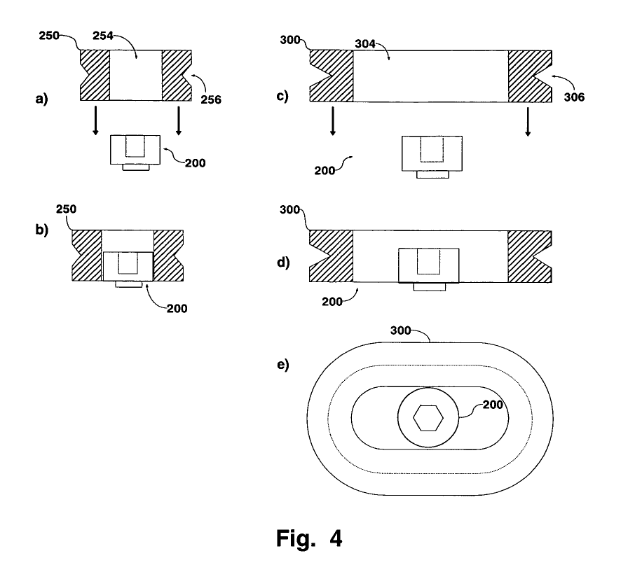

FIG. 4 is a diagram of cut-away views of a locating pin 200 (of FIG. 1), a round collar 250 (of FIG. 2), and an elongated collar 300 (of FIG. 3) illustrating how the collars 250 and 300 may be mounted on the locating pin 200. In FIG. 4a, the hole 254 formed in the round collar 250 is aligned with the locating pin 200. The round collar 250 is slid onto the locating pin 200, as illustrated by the arrows. FIG. 4b illustrates the round collar 250 after it is slid onto the locating pin 200. The round collar 250 includes a notch 256 formed in the periphery of the collar 250. In FIG. 4c, the hole 304 formed in the elongated collar 300 is aligned with the locating pin 200. The elongated collar 300 is slid onto the locating pin 200, as illustrated by the arrows. FIG. 4d illustrates the elongated collar 300 after it is slid onto the locating pin 200. The elongated collar 300 includes a notch 306 formed in the periphery of the elongated collar 300. FIG. 4e is a top view illustrating how the elongated collar 300 fits on the locating pin 200. The minor axis of the elongated collar 300 is sized to fit the locating pin 200 and the major axis is sized larger than the locating pin 200 to allow for variations in the location of the locating pin 200.

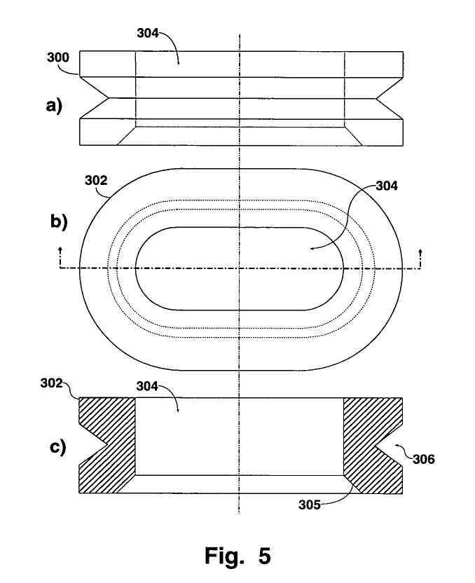

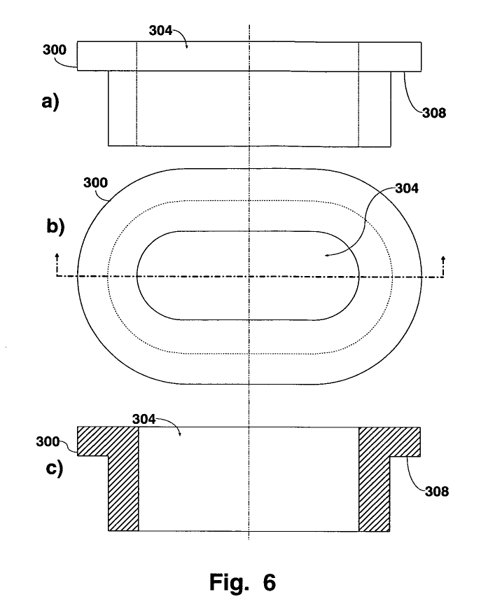

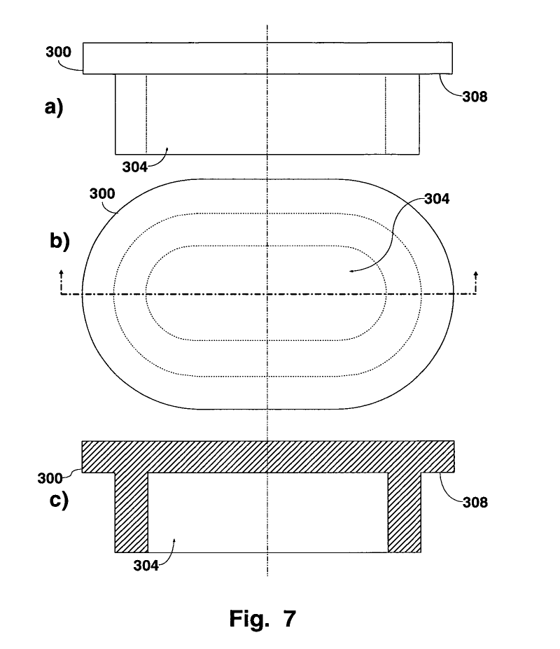

FIG. 5 is a diagram of an alternate embodiment of an elongated collar 300. In FIG. 5, a bevel 305 is formed at one end of the hole 304. The bevel 305 makes it easier to slide the collar 300 over the locating pin 200 (of FIG. 1). The remainder of the collar 300 of FIG. 5 is identical to that illustrated in FIG. 3. FIG. 6 is a diagram of another alternate embodiment of an elongated collar 300. In FIG. 6, instead of a notch 306, as illustrated in FIG. 2, FIG. 3, and FIG. 5, the collar 300 includes a flange 308. In FIG. 6, the hole 304 goes completely through the collar 302. The remainder of the collar 300 illustrated in FIG. 6 is identical to that illustrated in FIG. 2. FIG. 7 is a diagram of another alternate embodiment of a collar 300. As illustrated in FIG. 6, the collar 300 illustrated in FIG. 7 includes a flange 308. In this case, the hole 304 is open only at the bottom, and is closed at the top. The remainder of the collar 300 of FIG. 7 is identical to that illustrated in FIG. 2. It is possible for the collars illustrated in FIG. 6 and FIG. 7 to include a bevel, such as the bevel 305 illustrated in FIG. 5 to make it easier to slide the collar 300 over the locating pin 200. It is further possible for the round collar 250 to include a bevel as illustrated in FIG. 5, and to include a flange instead of a notch 306, as illustrated in FIG. 6 and FIG. 7.

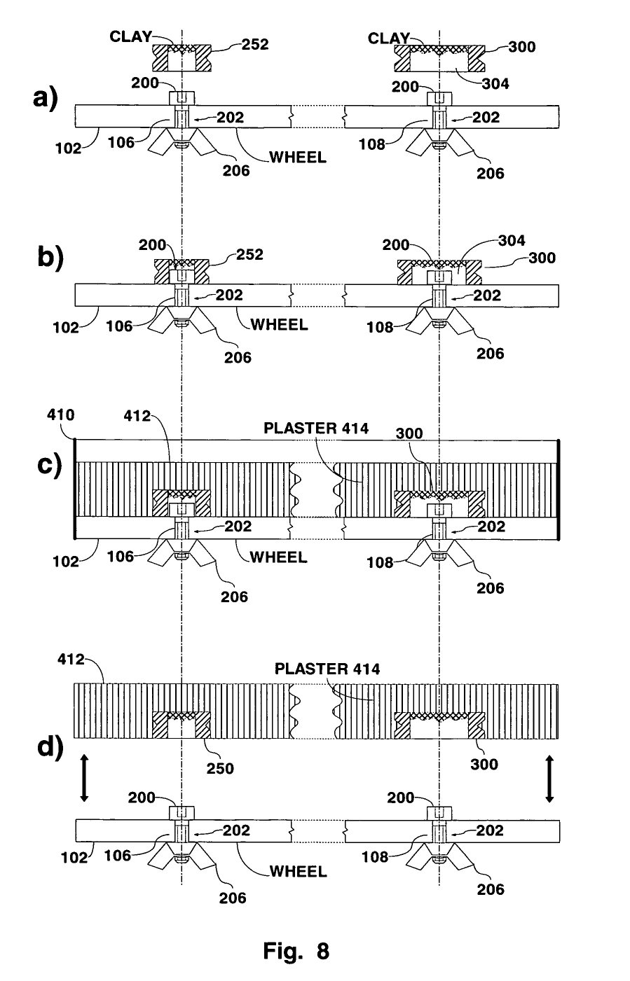

FIG. 8 is a diagram illustrating the use of the locating pin 200 illustrated in FIG. 1, the round collar 250 illustrated in FIG. 2 and the elongated collar 300 illustrated in FIG. 3 to make a plaster bat using a pottery wheel as illustrated in FIG. 1. Any of the other embodiments of a collar 300 (FIG. 5, FIG. 6, FIG. 7) may be used in the manner described below and illustrated in FIG. 8. The first step is illustrated in FIG. 8a. Two locating pins 200, consisting in the illustrated embodiment of respective ¼-20 hex head bolts 202 and corresponding wing nuts 206, are attached to the pottery wheel 102. Both locating pins 200 are bolted into their respective holes 106 and 108 at their respective nominal locations. In FIG. 8b, respective collars 250 and 300 (FIG. 2, FIG. 3) are slid over the two locating pins 200. For the embodiments of the collar including an open hole 304 (FIG. 2, FIG. 3, FIG. 5, FIG. 6), a bit of clay, illustrated by double-crosshatching, is placed in the open end of the collars 300. This prevents plaster from entering the opening of the collars 250, 300. A potter will understand that any material which is impervious to plaster may be used instead of clay, though clay will be readily available to a potter. For the embodiment of the collar 300 with a closed hole 304 (FIG. 7) this is not necessary.

In FIG. 8c, the plaster bat 412 is formed. First a dam 410 is formed around the outside edge of the pottery wheel 102. This may be formed by using tape, in a known manner. This dam 410 forms the sides of a well for which the pottery wheel is the bottom. The locating pins 200 are bolted to the bottom of the pottery wheel 102 and the collars 250, 300 (with clay in the open end, if necessary) are mounted on the locating pins 200. The round collar 250 remains centered on the corresponding locating pin 200. The elongated collar 300 is preferably located so that the locating pin 200 is substantially at the center of the elongated hole 304. In addition, the elongated collar 300 is preferably oriented so that the major axis is aligned with a radius of the pottery wheel 102. That is the major axis of the elongated collar is aligned radially on the pottery wheel 102. Plaster of an appropriate consistency is poured into the well to a desired depth and allowed to set.

As used in the present application, the term “plaster” is intended to mean any gypsum-based material which, when set, will form an appropriate porous bat. One skilled in the art understands such gypsum-based material may include, for example: ‘No. 1 Pottery Plaster’®, ‘Hydro-Stone’®, ‘Hydrocal’®, or ‘Ultracal’® (all products of United States Gypsum Company) or any combination of these or other similar products.

In FIG. 8d, the plaster 414 is set. The dam 410 is removed, and the plaster bat 412 removed from the pottery wheel 102. As may be seen, the collars 250, 300 remain embedded in the plaster bat 412 at locations corresponding to the nominal locations of the locating pins 200, while the locating pins 200 remain bolted to the pottery wheel 102. In the illustrated embodiments, the collars 250, 300 include means for being retained in the plaster bat 412. Referring to the collars 300 illustrated in FIG. 2, FIG. 3 and FIG. 5, the plaster 414 forms in the notch 306 and prevents the collar 300 from slipping out of the plaster bat 412 when it is removed from the pottery wheel 102. Referring to the collars 300 illustrated in FIG. 6 and FIG. 7, the plaster 414 forms around the flange 308 and prevents the collar 300 from slipping out of the plaster bat 412 when it removed from the pottery wheel 102.

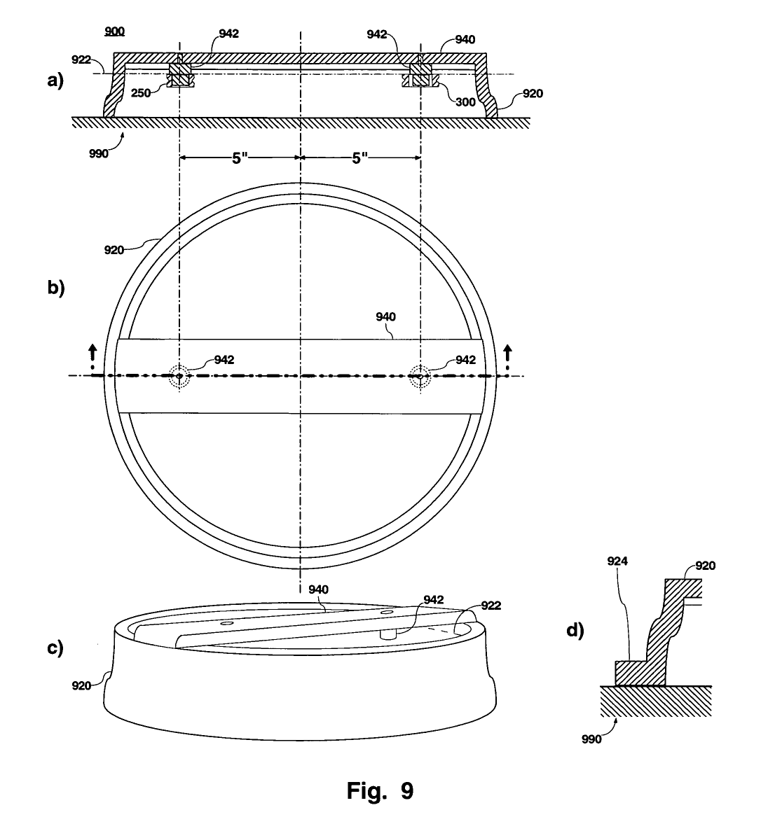

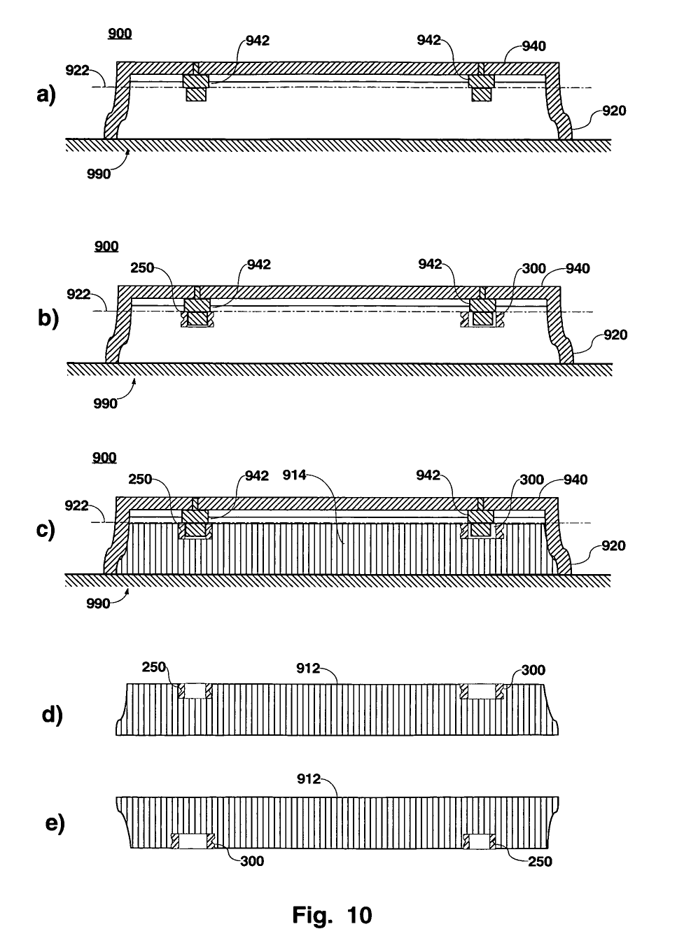

An alternative apparatus and method for fabricating plaster bats according to the present invention is illustrated in FIG. 9 and FIG. 10. FIG. 9a and FIG. 9b are orthographic views and FIG. 9c is an isometric view of a mold 900 for fabricating plaster bats including a round collar 250 and an elongated collar 300 (as illustrated in FIG. 2, FIG. 3, FIG. 5, FIG. 6, and/or FIG. 7). The mold 900 of FIG. 9 consists of two portions: a well portion 920 and a bridge portion 940. The well portion 920 is substantially cylindrical and is open at the bottom and top. The bridge portion 940 is shaped to fit across the top of the well portion 920. The bridge portion 940 includes two collar holders 942. The collar holders 942 are nominally located at five inch radii along a diameter of the well portion 920 of the mold 900, i.e. corresponding to the nominal locations of the locating pins 200 on the pottery wheel 102 (FIG. 1). The collar holders 942 are fabricated so that a round collar 250 and/or an elongated collar 300, as illustrated in FIG. 2, FIG. 3, FIG. 5, FIG. 6, and/or FIG. 7 may be slid onto them and retained at a predetermined height. The collar holders 942 are illustrated as being mounted in respective holes in the bridge portion 940. However, any method of placing a collar holder on the bridge portion 940 may be used, including adhesives, spin welding, or molding the collar holders 942 as a unitary part of the bridge portion 940 or the mold 900. The mold 900 is preferably fabricated as a single unitary piece from e.g. ABS plastic.

FIG. 9d is a more detailed diagram of a portion of another embodiment of the mold 900. FIG. 9d is a cut-away view of a portion of the wall of the well portion 920. At the bottom of the well portion 920, along the bottom surface which is placed on the smooth hard surface 990 is a flange 924. This flange runs around the complete circumference of the well portion 920. The flange 924 provides a top surface area which allows one or more clamps to be used to hold the mold 900 tightly to the smooth hard surface 990.

Referring now to FIG. 10, FIG. 10a illustrates a cut-away side view of the mold 900. In FIG. 10a, the mold 900 is placed on a relatively hard smooth surface 990. The well portion 920 is placed against the surface 990 with the bridge portion 940 at the top. The collar holders 942 project downward. Clay may be used where the mold 900 meets the relatively hard smooth surface 990 to form a seal. If the well portion 920 includes a flange, as illustrated in FIG. 9d, the mold 900 may be clamped to the relatively smooth hard surface.

A round collar 250 is slid onto one of the collar holders 942 and an elongated collar 300 is slid onto the other one of the collar holders 942, as illustrated in FIG. 10b. The round collar 250 is centered on the corresponding collar holder 942. The elongated collar 300 is preferably located so that the corresponding collar holder 942 is substantially centered in the elongated hole 304. In addition, the elongated collar 300 is preferably oriented so that the major axis is aligned with a radius of the mold 900. Alternatively, one of the collar holders 942 may be fabricated to have the same shape as the opening of an elongated collar 300 with a major axis radially oriented. Such a collar holder 942 accepts and holds an elongated collar 300 in substantially the nominal location with its major axis radially oriented. A fill-line 922 is established at the top of the collars 300. This fill-line 922 may also displayed on the inside wall of the well portion 920 for the potter to see.

In FIG. 10c, plaster 914 of an appropriate consistency is poured into the well portion 920 and allowed to set. In FIG. 10d, the plaster is set and the plaster bat 912 is formed. The mold 900 is lifted from the relatively hard smooth surface 900. As may be seen, the collars 250 and 300 remain embedded in the plaster bat 912 at locations corresponding to the nominal locations of the locating pins 200 in the pottery wheel 102 (FIG. 1). As described above with respect to FIG. 8, the collars 250, 300 include means for being retained in the plaster bat 912. The plaster bat 912 is inverted, as illustrated in FIG. 10e and may be removably mounted on a pottery wheel 102.

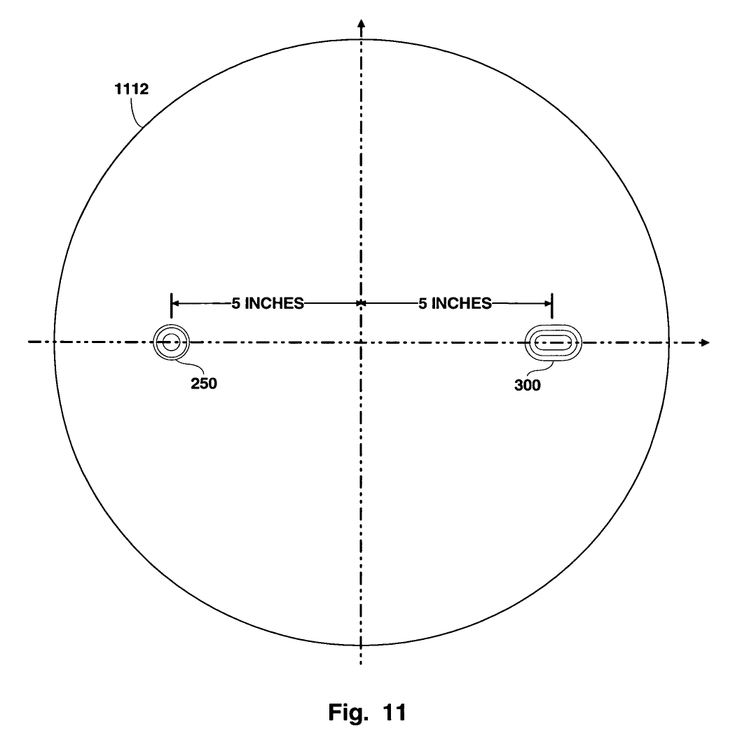

FIG. 11 is a diagram of a plaster bat 1112 fabricated according to principles of the present invention as illustrated in FIG. 8 or FIG. 10. FIG. 11 is a bottom view of a plaster bat 1112. In FIG. 11, the round collar 250 is visible on the left hand side. The substantially round hole formed by the round collar 250 is at a location corresponding to the nominal location of the locating pin 200 (FIG. 1), i.e. along a diameter and at a radius of 5 inches. The elongated collar 300 is visible on the right hand side. The major axis of the elongated collar 300 is aligned with the radius of the plaster bat 1112, and the center of the elongated hole formed by the elongated collar 300 is at a location corresponding to the nominal location of the locating pin, i.e. along a diameter and at a radius of 5 inches. Other methods than those illustrated in FIG. 8 or FIG. 10 for forming plaster bats including a round collar 250 and an elongated collar 300 according to the present invention may used to fabricate plaster bats according to principles of the present invention.

The arrangement described above allows a plaster bat 1112 to be easily and economically fabricated to hold completed or partially completed work-pieces, and allows that plaster bat 1112 to be used on a plurality of different pottery wheels 102 which have locating pins at nominal locations, though the locations may vary from the exact nominal locations on different pottery wheels. A plaster bat 1112, as illustrated in FIG. 11, fabricated using the collars 250 and 300 as illustrated in FIG. 2, FIG. 3, FIG. 5, FIG. 6, and FIG. 7 is able to fit on pottery wheels which have locating pins which vary from the nominal locations. The locating pins may be the relatively standard bolt-heads described above.

To fit a plaster bat 1112 on a pottery wheel 102 (FIG. 1) having locating pins 200 at nominal locations, the substantially round hole in the round collar 250 is aligned with one of the locating pins 200, then the elongated hole in the elongated collar 300 is aligned with the other one of the locating pins 200. Once the collars 250, 300 are aligned with the locating pins 200, the plaster bat 1112 may be slid onto the locating pins 200. Because the collars 250 and 300 are fabricated from relatively abrasion resistant material, a bat 1112 made with such collars 250, 300 may be dismounted and remounted repeatedly without deterioration of the mounting holes formed by the collars 250, 300.

A kit may be formed including one or more sets of one round collar 250, such as is as illustrated in FIG. 2, and one elongated collar 300, such as is illustrated in FIG. 3, FIG. 5, FIG. 6, or FIG. 7. The kit may further include two locating pins 200, i.e. two ¼-20 hex-head bolts 202 and/or two wing nuts 206, as illustrated in FIG. 1. It is anticipated, however, that the bolts and wing nuts are standard sized items widely available in hardware stores or other similar locations. It is further possible to supply a plaster bat fabricated as illustrated in FIG. 8 or FIG. 11 for use by potters on pottery wheels 102 which have locating pins 200 at the nominal locations illustrated in FIG. 1.

What is claimed is:

1. A porous bat, for use on a pottery wheel comprising a locating pin at a nominal location, the porous bat comprising an elongated hole at a location corresponding to the nominal location adapted to slidably fit over the locating pin, the hole having a first axis with a dimension sized to fit over the locating pin and a second axis with a dimension larger than the first dimension to compensate for variations in the location of the locating pin on the pottery wheel.

2. The porous bat of claim 1 wherein the second axis of the hole is aligned with a radius of the porous bat.

3. The porous bat of claim 1 wherein the elongated hole is formed by an elongated collar in the porous bat.

4. The porous bat of claim 3 wherein the elongated collar comprises a means for being retained when fabricated in the porous bat.

5. The porous bat of claim 4 wherein the retaining means comprises a notch formed in the periphery of the elongated collar.

6. The porous bat of claim 4 wherein the retaining means comprises a flange formed on the periphery of the elongated collar.

7. The porous bat of claim 3 wherein the elongated collar comprises a bevel to ease sliding the elongated collar onto the locating pin.

8. The porous bat of claim 3 wherein the elongated collar is fabricated from an abrasion resistant material.

9. The porous bat of claim 1 wherein the pottery wheel further comprises a second locating pin attached to the pottery wheel at a second nominal location, and:
the porous bat further comprising a substantially round hole, at a location corresponding to the second nominal location, adapted to slidably fit over the second locating pin.

10. The porous bat of claim 9 wherein the substantially round hole is formed by a round collar in the porous bat.

11. The porous bat of claim 3 wherein the round collar comprises a means for being retained when fabricated in the porous bat.

12. The porous bat of claim 3 wherein the retaining means comprises a notch formed in the periphery of the round collar.

13. The porous bat of claim 3 wherein the retaining means comprises a flange formed on the periphery of the round collar.

14. The porous bat of claim 3 wherein the round collar comprises a bevel to ease sliding the round collar onto the second locating pin.

15. The porous bat of claim 10 wherein the round collar is fabricated from an abrasion resistant material.

16. The porous bat of claim 1 wherein the porous bat is fabricated from gypsum-based material.

17. The porous bat of claim 16 wherein the gypsum-based material is selected from a group consisting of: ‘No. 1 Pottery Plaster’®, ‘Hydro-Stone’®, ‘Hydrocal’®, or ‘Ultracal’®.

18. A method for removably mounting a porous bat on a pottery wheel, comprising the steps of:
attaching a locating pin to a nominal location on the pottery wheel;
fabricating a porous bat with an elongated hole at a location corresponding to the nominal location, the hole having a first axis with a dimension sized to slidably fit over the locating pin and a second axis with a dimension larger than the first dimension to compensate for variations in the location of the locating pin on the pottery wheel;
aligning the elongated hole with the locating pin; and
sliding the elongated hole on the locating pin.

19. The method of claim 18 wherein the second axis is aligned with a radius of the porous bat.

20. The method of claim 18 wherein the step of fabricating the porous bat comprises the step of fabricating the porous bat to comprise an elongated collar forming the elongated hole.

21. The method of claim 18:
further comprising the step of attaching a second locating pin at a second nominal location on the pottery wheel;
wherein the step of fabricating a porous bat comprises fabricating the porous bat to further comprise a substantially round hole at a second location corresponding to the second nominal location, the hole adapted to slidably fit over the second locating pin; and
further comprising, before the step of aligning the elongated hole, the step of aligning the substantially round hole in the porous bat with the second locating pin.

22. The method of claim 21 wherein the step of fabricating the porous bat comprises the step of fabricating the porous bat to comprise a round collar forming the substantially round hole.

23. The method of claim 18 wherein the step of fabricating the porous bat comprises the step of fabricating the porous bat from gypsum-based material.

24. The method of claim 23 wherein the gypsum-based material is selected from a group consisting of: ‘No. 1 Pottery Plaster’®, ‘Hydro-Stone’®, ‘Hydrocal’®, or ‘Ultracal’®.

25. A method for removably mounting a porous bat on a pottery wheel comprising a locating pin at a nominal location, comprising the steps of:
fabricating a porous bat with an elongated hole at a location corresponding to the nominal location, the hole having a first axis with a dimension sized to slidably fit over the locating pin and a second axis with a dimension larger than the first dimension to compensate for variations in the location of the locating pin on the pottery wheel;
aligning the elongated hole with the locating pin; and
sliding the elongated hole on the locating pin.

26. The method of claim 23 wherein the second axis is aligned with a radius of the porous bat.

27. The method of claim 23 wherein the step of fabricating the porous bat comprises the step of fabricating the porous bat including an elongated collar forming the elongated hole.

28. The method of claim 23 wherein the pottery wheel further comprises a second locating pin at a second nominal location:
wherein the step of fabricating a porous bat comprises fabricating the porous bat further comprising a substantially round hole at a second location corresponding to the second nominal location, the hole adapted to slidably fit over the second locating pin; and
further comprising, before the step of aligning the elongated hole, the step of aligning the substantially round hole in the porous bat with the second locating pin.

29. The method of claim 28 wherein the step of fabricating the porous bat comprises the step of fabricating the porous bat including a round collar forming the substantially round hole.

30. The method of claim 23 wherein the step of fabricating the porous bat comprises the step of fabricating the porous bat from gypsum-based material.

31. The method of claim 30 wherein the gypsum-based material is selected from a group consisting of: ‘No. 1 Pottery Plaster’®, ‘Hydro-Stone’®, ‘Hydrocal’®, or ‘Ultracal’®.

32. A method for removably mounting a porous bat on a pottery wheel comprising a locating pin at a nominal location, the porous bat having an elongated hole at a location corresponding to the nominal location, the hole having a first axis with a dimension sized to fit over the locating pin and a second axis with a dimension larger than the first dimension to compensate for variations in the location of the locating pin on the pottery wheel, comprising the steps of:
aligning the elongated hole with the locating pin; and
sliding the elongated hole on the locating pin.

33. The method of claim 30 wherein the pottery wheel further comprises a second locating pin at a second nominal location and the porous bat further comprises a substantially round hole at a second location corresponding to the second nominal location adapted to slidably fit over the second locating pin, the method further comprising, before the step of aligning the elongated hole with the locating pin, the step of aligning the substantially round hole with the second locating pin.

34. A method for fabricating a porous bat capable of being removably mounted on a pottery wheel comprising a locating pin at a nominal location, the method comprising the step of fabricating a porous bat with an elongated hole at a location corresponding to the nominal location, the hole having a first axis with a dimension sized to slidably fit over the locating pin and a second axis with a dimension larger than the first dimension to compensate for variations in the location of the locating pin on the pottery wheel.

35. The method of claim 34 wherein the second axis is aligned with a radius of the porous bat.

36. The method of claim 34 wherein the step of fabricating the porous bat comprises the step of fabricating the porous bat including an elongated collar forming the elongated hole.

37. The method of claim 34 wherein the pottery wheel further comprises a second locating pin at second nominal location, and the step of fabricating the porous bat comprises fabricating the porous bat further comprising a substantially round hole at a second location corresponding to the second nominal location adapted to slidably fit over the second locating pin.

38. The method of claim 37 wherein the step of fabricating the porous bat comprises the step of fabricating the porous bat including a round collar forming the substantially round hole.

39. The method of claim 34 wherein the step of fabricating the porous bat comprises the step of fabricating the porous bat from gypsum-based material.

40. The method of claim 39 wherein the gypsum-based material is selected from a group consisting of: ‘No. 1 Pottery Plaster’®, ‘Hydro-Stone’®, ‘Hydrocal’®, or ‘Ultracal’®

41. A porous bat fabricated according to the method recited in claim 34.

42. A method for fabricating a porous bat capable of being removably mounted on a pottery wheel having a locating pin attached at a nominal location, comprising the steps of:
sliding an elongated collar over the locating pin, the elongated collar forming an elongated hole having a first axis with a dimension sized to fit over the locating pin and a second axis with a dimension larger than the first dimension to compensate for variations in the location of the locating pin on the pottery wheel;
constructing a dam around the pottery wheel;
pouring gypsum-based material in the dam;
allowing the gypsum-based material to set;
removing the dam; and
removing the porous bat, including the elongated collar at a location corresponding to the nominal location, from the pottery wheel.

43. The method of claim 42 wherein the step of sliding an elongated collar over the locating pin comprises the step of aligning the elongated collar such that the second axis is aligned with a radius of the pottery wheel.

44. The method of claim 43 wherein the step of sliding an elongated collar over the locating pin comprises the step of centering the locating pin within the elongated hole formed by the elongated collar.

45. The method of claim 42 wherein the pottery wheel further has a second locating pin attached at a second nominal location, further comprising the step of:
before the pouring step, sliding a round collar over the second locating pin, the round collar forming a substantially round hole having a dimension sized to fit over the second locating pin.

46. The method of claim 42 further comprising the step of, before the pouring step, placing material impervious to gypsum-based material in the top of the collar whereby gypsum-based material will not enter into the collar.

47. The porous bat of claim 42 wherein the gypsum-based material is selected from a group consisting of: ‘No. 1 Pottery Plaster’®, ‘Hydro-Stone’®, ‘Hydrocal’®, or ‘Ultracal’®

48. A porous bat fabricated according to the method of claim 42.

49. A mold for fabricating a porous bat capable of being removably mounted on a pottery wheel comprising a locating pin at a nominal location, the mold comprising:
a well portion, adapted to be placed on a relatively smooth hard surface, and forming a well adapted to contain gypsum-based material;
a bridge portion, attached to the well portion, and comprising a collar holder adapted to hold an elongated collar within the well portion at a location corresponding to the nominal location, the elongated collar forming an elongated hole adapted to slidably fit over the locating pin, the hole having a first axis with a dimension sized to fit over the locating pin and a second axis with a dimension larger than the first dimension to compensate for variations in the location of the locating pin on the pottery wheel; wherein:
the collar holder is adapted to hold the elongated collar at a predetermined height above the surface.

50. The mold of claim 49 wherein the well portion comprises a flange around the periphery adapted to be adjacent the smooth hard surface, whereby the mold may be clamped to the smooth hard surface.

51. The mold of claim 49 wherein:
a fill line is made visible on the well portion; and
the predetermined height is specified so that the top of the elongated collar is at the fill line.

52. The mold of claim 49 wherein the pottery wheel further comprises a second locating pin at a second nominal location:
the bridge portion further comprising a second collar holder adapted to hold a round collar within the well portion at a location corresponding to the second nominal location, the round collar forming a substantially round hole adapted to slidably fit over the second locating pin.

53. A method for fabricating a porous bat capable of being removably mounted on a pottery wheel comprising a locating pin at a nominal location using a mold comprising a well portion, adapted to be placed on a relatively smooth hard surface, and forming a well adapted to contain gypsum-based material; a bridge portion, attached to the well portion, and comprising a collar holder adapted to hold an elongated collar within the well portion at a location corresponding to the nominal location, the elongated collar forming an elongated hole adapted to slidably fit over the locating pin, the hole having a first axis with a dimension sized to fit over the locating pin and a second axis with a dimension larger than the first dimension to compensate for variations in the location of the locating pin on the pottery wheel; wherein the collar holder is adapted to hold the elongated collar at a predetermined height above the surface, the method comprising the steps of:
sliding an elongated collar on the collar holder;
placing the mold on a relatively smooth hard surface;
pouring gypsum-based material into the well portion;
allowing the gypsum-based material to set; and
removing the porous bat, including the elongated collar forming an elongated hole at a location corresponding to the nominal location.

54. The method of claim 53 wherein the well portion further comprises a flange around the periphery adapted to be adjacent the smooth hard surface, whereby the mold may be clamped to the smooth hard surface, and the method further comprises the step of clamping the mold to the relatively smooth hard surface.

55. The method of claim 53 wherein the pottery wheel further comprises a second locating pin at a second nominal location; and the bridge portion further comprises a second collar holder adapted to hold a round collar within the well portion at a location corresponding to the second nominal location, the round collar forming a substantially round hole adapted to slidably fit over the second locating pin, the method further comprising, before the step of pouring gypsum-based material, the step of sliding a round collar on the second collar holder.

56. A porous bat fabricated according to the method of claim 53.

57. A kit for facilitating removably mounting a porous bat on a pottery wheel comprising a locating pin at a nominal location, comprising:
an elongated collar, forming an elongated hole having a first axis with a dimension sized to slidably fit over the locating pin, and a second axis with a dimension larger than the first dimension to compensate for variations in the location of the locating pin on the pottery wheel; whereby:
when the elongated collar is fabricated in a porous bat at a location corresponding to the nominal location, the elongated hole formed by the elongated collar may be aligned with the locating pin and the porous bat may be removably mounted on the pottery wheel.

58. The kit of claim 57 wherein the elongated collar comprises a means for being retained when fabricated in a porous bat.

59. The kit of claim 58 wherein the retaining means comprises a notch formed in the periphery of the elongated collar;

60. The kit of claim 58 wherein the retaining means comprises a flange formed in the periphery of the elongated collar.

61. The kit of claim 57 wherein the elongated collar comprises a bevel to ease sliding the elongated collar onto the locating pin.

62. The kit of claim 57 wherein the elongated collar is fabricated from an abrasion resistant material.

63. The kit of claim 57 for facilitating removably mounting a porous bat on a pottery wheel comprising a second locating pin at a second nominal location, further comprising a round collar, forming a substantially round hole sized to slidably fit over the second locating pin; whereby:
when the round collar is fabricated in the porous bat at a location corresponding to the second nominal location, the substantially round hole may be aligned with the second locating pin, the elongated hole may be aligned with the first mentioned locating pin and the porous bat may be slidably mounted on the pottery wheel.

64. The kit of claim 63 further comprising the first mentioned and the second locating pins capable of being attached to the pottery wheel at the first mentioned and the second nominal locations.

65. The kit of claim 63 wherein the round collar comprises a means for being retained when fabricated in a porous bat.

66. The kit of claim 65 wherein the retaining means comprises a notch formed in the periphery of the round collar.

67. The kit of claim 65 wherein the retaining means comprises a flange formed in the periphery of the round collar.

68. The kit of claim 63 wherein the round collar comprises a bevel to ease sliding the round collar onto the second locating pin.

69. The kit of claim 63 wherein the round collar is fabricated from an abrasion resistant material.

70. The kit of claim 63 further comprising a mold comprising a well portion, adapted to be placed on a relatively smooth hard surface, and forming a well adapted to contain gypsum-based material; and a bridge portion, attached to the well portion, and comprising a first collar holder adapted to hold the elongated collar within the well portion at a location corresponding to the first mentioned nominal location and a second collar holder adapted to hold the round collar within the well portion at a location corresponding to the second nominal location.

71. The kit of claim 57 wherein the kit further comprises a locating pin capable of being attached to the pottery wheel at the nominal location.

72. The kit of claim 57 further comprising a mold comprising a well portion, adapted to be placed on a relatively smooth hard surface, and forming a well adapted to contain gypsum-based material; and a bridge portion, attached to the well portion, and comprising a collar holder adapted to hold the elongated collar within the well portion at a location corresponding to the nominal location.
